(19) United States
(12) Patent Application Publication
(10) Pub. No.: US 2017/0249013 A1
(43) Pub. Date: Aug. 31, 2017

(54) TOUCHPAD SYSTEM WITH MULTIPLE TRACKING METHODS: MECHANICAL FORCE POSITIONAL SENSOR INTEGRATED WITH CAPACITIVE LOCATION TRACKING

(71) Applicant: CIRQUE CORPORATION, Salt Lake City, UT (US)

(72) Inventors: Paul H. Glad, Taylorsville, UT (US); Alan Stettler, Salt Lake City, UT (US); Doug Steck, Salt Lake City, UT (US); Jon Alan Bertrand, Taylorsville, UT (US)

(21) Appl. No.: 15/443,175

(22) Filed: Feb. 27, 2017

Related U.S. Application Data
(60) Provisional application No. 62/299,727, filed on Feb. 25, 2016.

(51) Int. Cl. G06F 3/01; G06F 3/0354; G06F 3/044

(52) U.S. Cl. CPC G06F 3/016; G06F 3/044; G06F 3/03547; G06F 2203/04101; G06F 2203/04102; G06F 2203/04105

(57) ABSTRACT

A system and method for enabling an entire touchpad surface to mechanically move if sufficient force is used to press on the touchpad to perform a mouse click function, such as a right click or a left click, when the touchpad is mechanically buttonless, such as a forcepad, in order to provide haptic feedback on a touchpad that otherwise has none.

### BACKGROUND OF THE INVENTION

Field of the Invention

This Invention relates generally to touch sensors and force sensors. Specifically, the invention pertains to a system and method for enabling an entire touchpad surface to mechanically move if sufficient force is used to press on the touchpad to perform a mouse click function.

Description of Related Art

There are several designs for capacitance sensitive touch sensors which may take advantage of a system and method for providing mechanical movement of a touchpad that is buttonless. It is useful to examine the underlying technology of the touch sensors to better understand how any capacitance sensitive touchpad can take advantage of the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

It should be understood that use of the term “touch sensor” throughout this document may be used interchangeably with “forcepad”, “buttonless touchpad”, “proximity sensor”, “touch and proximity sensor”, “touch panel”, “touchpad” and “touch screen”.

Buttonless touchpads and forcepads may be touch sensors that fail to provide a user friendly haptic feedback sensation of a mechanical “click” when pressed. While the touch sensors are still able to provide the functionality of the mouse click, they nevertheless may fail to provide tactile feedback that is not required to function, but may nevertheless be desirable to users.

Furthermore, many touch sensors do not allow the user to perform a mechanical click, right or left, at a top portion of the touchpad. This is an inherent design issue when the mechanical button(s) are mounted at the bottom area of the underside of the touch sensor surface because the touch sensor has a hinge near the upper area of the touchpad. It may be that these designs allow about 80% of the area of the touch sensor surface to be used for “clicking” because trying to get a mechanical click on the upper 20% of the touchpad is either not possible or requires excessive force.

There may be some touch sensors that do not allow any mechanical movement, but instead create an “artificial” click-type response using a haptic motor when the user presses anywhere on the touch sensor, such as in a forcepad. There may also be other forcepad designs that create an audible “click” sound as the user presses on a touch sensor which senses mechanical pressure. However, these touch sensors also lack mechanical movement of the touch sensor itself.

### BRIEF SUMMARY OF THE INVENTION

In a first embodiment, the present invention is a system and method for enabling an entire touchpad surface to mechanically move if sufficient force is used to press on the touchpad to perform a mouse click function, such as a right click or a left click, when the touchpad is mechanically buttonless, in order to provide haptic feedback on a touchpad that has no haptic feedback motor.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a touchpad that is found in the prior art, and which is adaptable for use in the present invention.

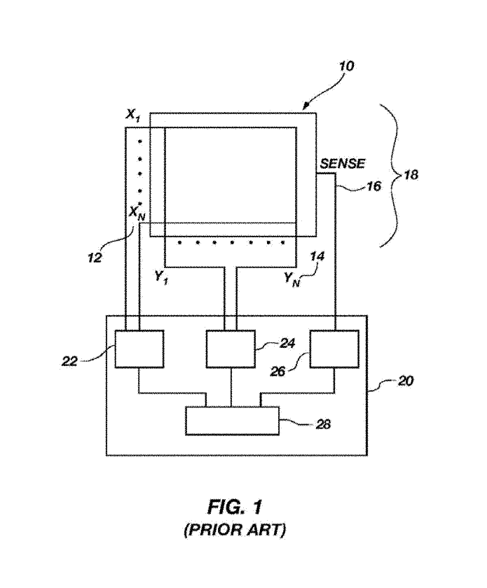

FIG. 2 is a picture of a top view of a substrate and touch sensor disposed thereon, the substrate having four flex arms on each corner of the touch sensor.

FIG. 3 is a perspective view of the bottom of a substrate showing a mechanical switch disposed in the center of the substrate to provide a mechanical switch when the touch sensor is pressed.

FIG. 4 is a view from an edge of the touch sensor showing that the substrate is only supported by the housing at a distal end of each of the four flex arms.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

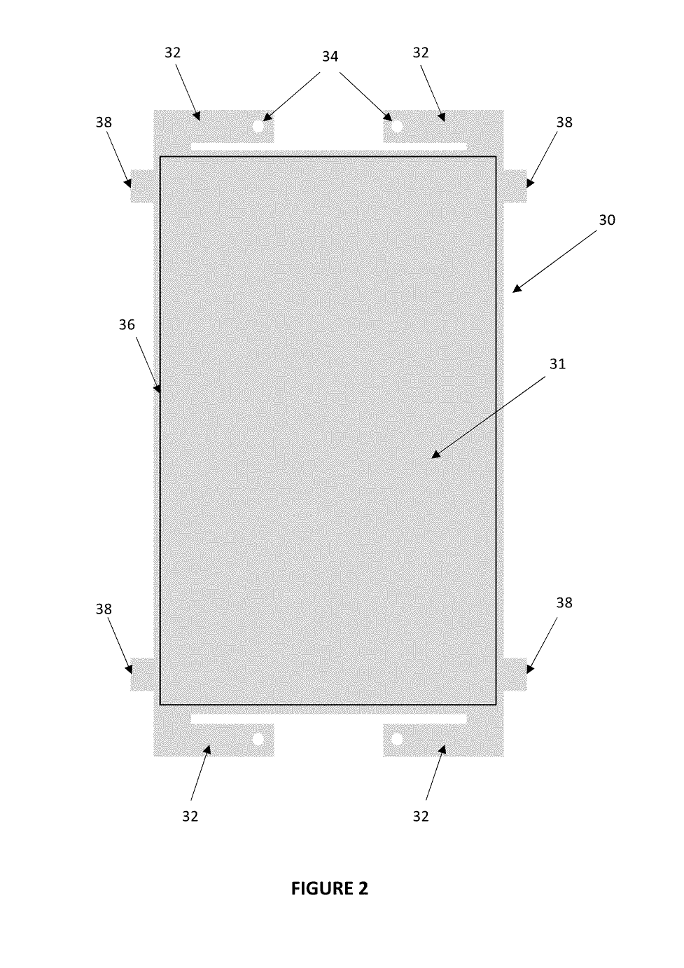

FIG. 2 is a top view of a first embodiment of a touch sensor 30. The touch sensor 30 has several features that enable it to provide the desired functionality. A first feature of the touch sensor 30 is a substrate 31. The substrate 31 may have four flex arms 32 that may suspend the touch sensor within a housing that is not shown. The substrate 31 of the touch sensor 30 may be manufactured from a single sheet of flexible material as shown in this first embodiment. For example, the substrate 31 may be comprised of printed circuit board (PCB). The PCB may be sufficiently flexible to enable the four flex arms 32 to provide the desired mechanical deflection action of the touch sensor 30.

In this first embodiment, the four flex arms 32 are shown with a hole 34 at the distal end of each one. The hole 34 in each flex arm 32 may be used to position and hold the touch sensor 30 in place within a housing. Applying a force to any portion of the touch surface 36 of the touch sensor 30 may result in the flexing of the four flex arms 32 where the flex arms are attached to the corners of the touch sensor.

Alternatively, the four flex arms 32 may not be an integral part of the substrate 31 of the touch sensor 30, but are instead mechanically joined to a touch sensor and may still provide the flexibility needed for the touch sensor to be mechanically manipulated by a force applied to the touch surface 36.

The length of each of the four flex arms 32 may be the same or they may vary. The four flex arms 32 may vary in width and length from that shown in FIG. 2. The four flex arms 32 may or may not have the holes 34 for positioning. The touch sensor 30 shown in FIG. 2 is for illustration purposes only, and the length and width of any part of the touch sensor may be varied and still fall within the first embodiment of the invention.

In this first embodiment, the touch sensor 30 may also include four small tabs 38. While the four flex arms 32 may be disposed on the short sides of the touch sensor 30, the tabs 38 may be disposed on the long sides of the touch sensor. The tabs 38 may function to prevent undesired movement of the touch sensor 30. For example, the four tabs 38 may be pivot points that may prevent the touch sensor 30 from lifting out of a housing and to instead assist the touch sensor in moving downward into the housing when a force is applied to the touch surface 36.

The position of the four tabs 38 along the long sides may be changed in order to obtain a different depth of movement of the touch sensor 30 when a force is applied to the touch surface 36, or they may be eliminated completely. Accordingly, the position of the four tabs 38 along the long sides may be changed in order to achieve different movement characteristics of the touch sensor 30 when a force is applied.

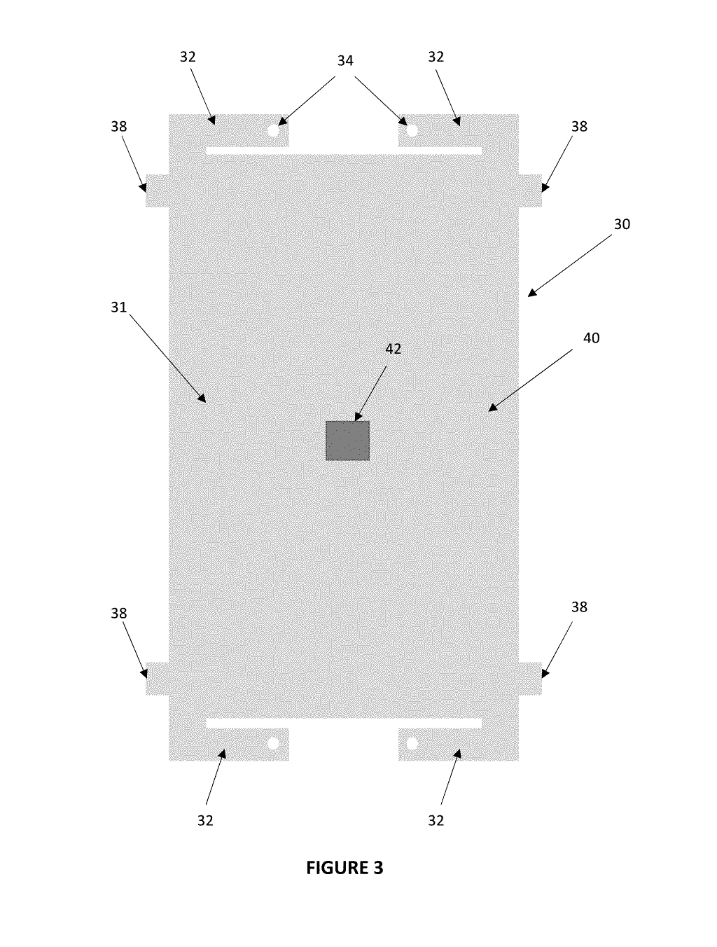

FIG. 3 is a view of a bottom side 40 of the touch sensor 30. The bottom side 40 shows a switch 42 that may be disposed in a center of the touch sensor 30. The switch 42 may provide a mechanical click. The mechanical click may be a haptic movement, a clicking sound, or both. The mechanical click may be caused by the switch 42 making contact with a housing underneath the touch sensor 30.

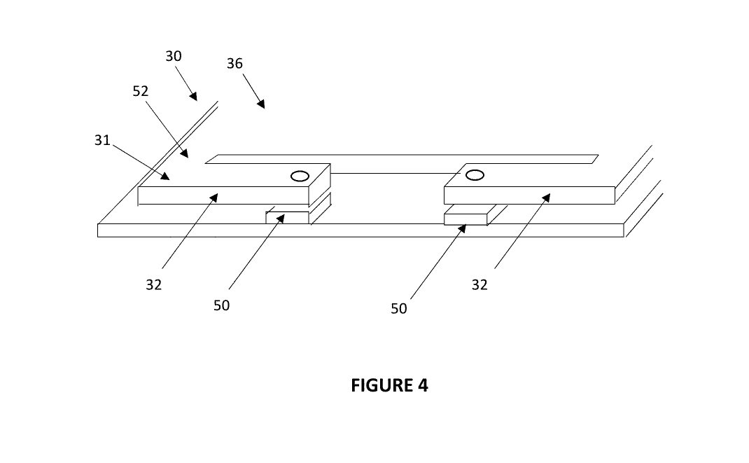

FIG. 4 is a partial side, top and perspective view of a portion of one end of the touch sensor 30 and supporting structures 50 from a side or edge. The supporting structures 50 may be part of a housing. The substrate 31 of the touch sensor 30 is shown as being supported by the flex arms 32. The flex arms 32 may be the only part of the touch sensor 30 to be in contact with the housing. When a force is applied to the touch surface 36 of the touch sensor 30, the touch sensor may travel downward towards the housing while supported by the four flex arms 32 until the switch 42 on the bottom side of the touch sensor makes contact with the housing.

One aspect of the first embodiment is that a force may be applied at any location on the touch surface 36 and still cause the entire touch sensor 30 to move toward the housing. However, the touch sensor 30 may be tilted if the force is being applied near an edge of the touch sensor so that some areas of the touch sensor move further towards the housing than other portions of the touch sensor. Nevertheless, all of the touch surface 36 may move down toward the housing as the force is applied. Movement may continue until the force is removed or until the switch 42 makes contact with the housing, preventing further movement of the touch sensor 30.

It is an aspect of the touch sensor 30 that the material used for the touch sensor will be flexible enough so that the touch sensor may return to an unflexed or rest position when the force is not being applied.

One advantage of the first embodiment and the use of four flex arms 32, one flex arm connected to the touch sensor 30 at each corner, is that the stress on the touch sensor at the joint 52 between the touch sensor and the four flex arms may be more evenly distributed across the touch sensor. Thus, it may be easier to cause the mechanical movement of the touch sensor 30. However, it may be undesirable to have the touch surface 36 flex when a force is applied to perform a mouse click function. One advantage of the first embodiment is that a material used to prevent flexing of the touch surface 36 may not have to be as rigid as when using only two flex arms when a hinge structure is being used on the touch sensor because the touch sensor will now move more easily with four flex arms 32.

Alternatively, a thickness of the material used to prevent flexing of the touch sensor 30 may not have to be as thick and thereby increasing sensitivity of the touch sensor.

Another aspect of the first embodiment is that a haptics feedback motor may be used to provide additional movement of the touch sensor 30. The additional movement of the touch sensor 30 may be a function of the amount of force or pressure that is applied to the touch sensor. The haptics feedback motor may therefore provide an additional degree of movement of the touch sensor 30.

Another aspect of the first embodiment may be a mechanical spring bias feature. A spring mounting platform may be provided having a ramped surface and an opposing feature that bends the spring to form a preloaded condition. The touch sensor may be pushed against an inside bezel surface when the touch sensor is at a rest position when no force is being applied.

It is noted that integrating mechanical force sensing elements into the PCB of a capacitive touch sensor design may add redundant tracking capability. The first embodiment may be used to compare two independent sets of tracking data to isolate noise sources present in one measurement system by means of using a second measurement tracking system and a method to concurrently correlate data between the two measurement systems, thus improving accuracy of the touch sensor.

Integrated force sensing features may be capacitive, resistive, magnetic or inductive in nature. These sensors may also be discrete components soldered to or attached mechanically to the surface of a PCB or housing.

The advantages of the system include PCB tabs or lever features that may include integrated capacitive sensing components designed into the touch sensor PCB solution. Evaluating data from multiple sensing component features may result in positional measurements being derived and correlated with a traditional capacitive tracking system. The additional redundant positional tracking system may allow noise, errors or other inaccurate data to be resolved by comparison between both sensing systems.

By reusing existing component analog and digital signals designed within the touch sensor, it may be possible to provide multiple redundant tracking system technologies. Data may be correlated and resolved between both systems, thus improving object tracking and position accuracy. An additional benefit may be the ability to measure touchdown force.

Another advantage may be that a force tracking method may eliminate water droplet interference issues associated with capacitive only tracking solutions.

It is noted that the first embodiment shows a rectangular substrate 31 for the touch sensor 30. However, the shape of the substrate 31 may be different. For example, the shape of the substrate may include circular, triangular, or any other shape that enables a touch sensor to be disposed thereon and which allows the touch sensor to flex on flex arms. Accordingly, the number of flex arms may also be different than four. The number of flex arms may vary and be as few as two and have as many flex arms as needed to allow movement of the touch sensor when a force is applied.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for providing mechanical movement of a surface of a touch sensor when a force is applied, said method comprising the steps of:
providing a substrate for a touch sensor, the substrate including a surface, the substrate having four flex arms, each one of the four flex arms being coupled to a different location of the substrate and flexing at a joint between the substrate and each of the four flex arms;
providing a housing for the touch sensor, the housing supporting the touch sensor at a distal end of each of the four flex arms;
providing a touch sensor on the surface of the substrate, wherein the touch sensor is a touch sensor having no mechanical buttons for performing mouse click functions; and
applying a force against the surface of the touch sensor and causing the substrate to move within the housing to provide haptic feedback to the user while the substrate is flexing at the joint of each of the four flex arms, to thereby provide movement to the touch sensor.

2. The method as defined in claim 1 wherein the method further comprises:
providing a mechanical switch on a bottom surface of the substrate, wherein movement of the substrate is stopped when the mechanical switch makes contact with the housing; and
providing a mechanical click action when the mechanical switch makes contact with the housing.

3. The method as defined in claim 2 wherein the method further comprises providing an audible sound with the mechanical click action.

4. The method as defined in claim 1 wherein the method further comprises only supporting the substrate at a distal end of each of the four flex arms.

5. The method as defined in claim 1 wherein the method further comprises returning the substrate to a rest position when the force is removed from the surface of the touch sensor.

6. The method as defined in claim 1 wherein the method further comprises forming the substrate as a rectangular shape and joining the four flex arms to the substrate at four corners of the substrate.

7. The method as defined in claim 6 wherein the method further comprises the step of inhibiting flexing of the touch sensor on the substrate by providing a material on the substrate that inhibits flexing.

8. The method as defined in claim 7 wherein the method further comprises increasing sensitivity of the touch sensor by reducing a thickness of the material used to inhibit flexing of the substrate.

9. The method as defined in claim 1 wherein the method further comprises the step of providing a haptic motor to increase haptic feedback of the touch sensor when a force is applied to the touch sensor that is sufficient to cause the substrate of the touch sensor to move.

10. A system for providing mechanical movement of a touch sensor when force is applied, said system comprised of:
a substrate for a touch sensor;
four flex arms wherein each one of the four flex arms is coupled to a different location of the substrate and flexing at a joint between the substrate and each of the four flex arms;
a housing for the touch sensor, the housing supporting the touch sensor at a distal end of each of the four flex arms; and
a touch sensor disposed on a surface of the substrate, wherein the touch sensor has no mechanical buttons for performing mouse click functions, and wherein applying a force against the surface of the touch sensor causes all the surface of the touch sensor to move within the housing to provide haptic feedback to the user while the substrate is flexing at the joint of each of the four flex arms, to thereby provide movement to the touch sensor.

11. The system as defined in claim 10 wherein the system is further comprised of:
a mechanical switch disposed on a bottom surface of the substrate, wherein movement of the substrate is stopped when the mechanical switch makes contact with the housing; and
a mechanical click action performed when the mechanical switch makes contact with the housing.

12. The system as defined in claim 11 wherein the system is further comprised an audible sound with the mechanical click action.

13. The system as defined in claim 10 wherein the system is further comprised of supporting the substrate at a distal end of each of the four flex arms.

14. The system as defined in claim 10 wherein the system is further comprised of forming the substrate as a rectangular shape, wherein the four flex arms are coupled to the substrate at four corners of the substrate.

15. The system as defined in claim 14 wherein the system is further comprised of providing a material on the substrate that inhibits flexing.

16. The system as defined in claim 15 wherein the system is further comprised of increasing sensitivity of the touch sensor by reducing a thickness of the material used to inhibits flexing of the substrate.

17. The system as defined in claim 10 wherein the system is further comprised of a haptic motor to increase haptic feedback of the touch sensor when a force is applied to the touch sensor that is sufficient to cause the substrate of the touch sensor to move.

18. A method for providing mechanical movement of the entire surface of a touch sensor when force is applied, said method comprising the steps of:
providing a substrate for a touch sensor, the substrate forming a rectangular surface, the substrate having four flex arms, each one of the four flex arms being coupled to a different corner of the rectangular surface and flexing at a joint between the substrate and the four flex arms;
providing a housing for the touch sensor, the housing supporting the touch sensor at an end of each of the four flex arms;
providing a touch sensor on the surface of the substrate, wherein the touch sensor is a buttonless touch sensor having no mechanical buttons for performing mouse click functions;
applying a force against the rectangular surface of the touch sensor and causing all the surface of the touch sensor to move within the housing to provide haptic feedback to the user while the substrate is flexing at the joint of each of the four flex arms, to thereby provide movement to the buttonless touch sensor.
